(19) United States
(12) Patent Application Publication
(10) Pub. No.: US 2011/0266820 A1
(43) Pub. Date: Nov. 3, 2011

(54) Console and seat gap protective device

(76) Inventor: Marni Markell Hurwitz, Far Hills, NJ (US)

(21) Appl. No.: 12/799,708

(22) Filed: May 1, 2010

(51) Int. Cl. B60J 9/00

(52) U.S. Cl. 296/1.07

(57) ABSTRACT

A console and bucket seat gap protective device prevents small items of importance from falling between a seat and console of a land vehicle, airplane or boat. The console and bucket seat gap protective device includes first and second parallel top edges that are generally appointed to secure the device onto the seat and console. The device further includes a central portion located between the parallel edges. The central portion is appointed to catch and house the small items of importance. It extends between the console and the seat to prevent items from falling there between. In one embodiment the central portion has a semi v-shape. In another embodiment the central portion has the shape of a semi arc. Other embodiments include LED or fiber optic lighting integrated therewithin for added illumination and enhanced visibility in dimly lit or darkened conditions. Fragrance sticks may be inserted to permeate a unique scent; or mask and neutralize unpleasant odors; or present a pleasant aroma.

### BACKGROUND OF THE INVENTION

1. Field Of The Invention

The present invention relates to a console and bucket seat divider device/gap protective device; and more particularly to a console and seat divider device comprising a first and second parallel top edge on either side of a semi v-shaped central portion having end walls wherein the first and second parallel top edges engage with a consol and proximate bucket seat and the central portion extends between the seat and console to secure items therein and prevent items from falling between the console and seat.

2. Description Of The Prior Art

Generally there is a gap between bucket seats and consoles in land vehicles. This gap can create an area wherein small objects and debris fall between the seat and console. Because the area between the seat and the console is very small, usually one inch or less, when items fall in the gap they are difficult to retrieve. As the use attempts to retrieve the item, it frequently becomes lodged in the gap and nearly impossible to recover with one's hand. Instead, long thin devices need to be employed to retrieve the object or item. Moreover, debris is known to fall within the gap, such as food particles, and can become wedged between the seat and the console.

Various devices have been provided in attempts to deal with the gap between seats and/or between a seat and console. However, the heretofore disclosed and utilized devices fail to provide a device that can readily be placed between the seats in a discrete manner that can securely hold items therein. The devices generally provide a generally flat surface that rests between the seat and console, but the generally flat surface oftentimes causes debris and/or items to fall off the surface and land on the floor. Generally, the devices do not provide the capacity to actually retain or house items therein.

U.S. Pat. No. 7,527,314 to Dohan discloses a vehicle gap guard for use in a motor vehicle that is constructed to fit and occupy the space between the outer most edge of a vehicle seat and the next closest compartment of the vehicle, which in most cases is a center console unit. The device may be configured in a variety of different arrangements, including dimensions suited for larger and/or smaller vehicles. It may be configured primarily for aftermarket installation in a vehicle, but with design functions and capabilities applicable to original equipment manufacturer. Additionally, the device may be constructed of fire retardant material and be made to be removabley attached to either the seat of the vehicle or a compartment (such as the center console) in close proximity to the seat. The device may be constructed of any appropriate lightweight material and may be made to custom fit a vehicle or for standard vehicle gap specifications. The device does not provide a semi-v shaped central construction and does not include accordion end portions for retaining items therein.

US Pat. App. Pub. No. 20090224563 to Gregory discloses an elastomeric blocker adapted to be inserted between the adjacent surfaces of a front seat of an automobile and a central console of an automobile to block the gap between the seat and the console and prevent articles from accumulating in the gap. The block has a central slit extending between its top and the bottom aligned longitudinally for the reception of the side seatbelt. A smooth sheet surface coating of fabric or plastic is attached to the section of the elastomer which contacts the central console, so that the blocker slides with the seat as it moves forwardly and rearward.

US Pat. App. Pub. No. 20070241581 to Martin discloses a debris deflector for occupying a gap disposed between, and having a shape and a width at least partially defined by, an automobile seat and an adjacent console. The deflector consists essentially of a resiliently deformable material and has a width greater than the width of the gap. The deflector is capable of reversible compressible conformation to the shape of the gap so as to obstruct the passage of objects into the gap. The specification further discloses a method for using such a debris deflector.

Notwithstanding the efforts of prior art workers to provide a gap protective device for placement between seats and consoles, i.e. center consoles, there remains a need in the art for a console and seat divider device that can be readily positioned between the seat and console in a quick, discrete manner. Further needed in the art is a device that is capable of holding and retaining small items of importance, such as credit cards, E-Z Pass Tags, keys, eye glasses, pens, and the like, so that the device may not only be used to prevent items such as jewelry, loose change, pens, cell phones and the like, from falling between the seat console gap, but can also provide a receptacle for storage of meter change, combs, cell phones, mini-flashlights, tire gages, and travel-related convenience items.

### SUMMARY OF THE INVENTION

The present invention provides a console and bucket seat divider device which is readily inserted within the gap between a seat and a console of a land vehicle, airplane or boat. Once in place, the device provides a receptacle for storage of convenience items, and virtually prevents loss of such items between the seat and console. Convenience items are readily reached, and fishing between the seat and console to retrieve lost items is virtually eliminated. The device is eminently portable. It can be readily removed and washed for reuse. Alternatively, it can be composed of coated paper, cardboard, plastic or other eco-friendly material for disposability. The device is lightweight, compact and easily moved from one location to another. The paper can be adorned with various printed designs, or kept plain for use as a note pad adjacent the console.

The console and seat divider device includes a first and second parallel top edge on either side of a semi v-shaped central portion having accordion end portions. The first and second parallel top edges engage with the consol and proximate bucket seat to support the device in position over a gap. The central portion extends between the seat and console to secure items therein and prevent items from falling between the console and seat.

The device is placed between the console and bucket seat of a land vehicle, airplane, boat or the like, to prevent items from falling there between. The gap protective divider is constructed from a lightweight, durable material including PVC materials, rubber, metal, foam leather, nylon mesh, or other various materials or mixtures thereof. Advantageously, the divider may be provided as a liquid impermeable material so that liquid spills will be retained in the divider's v-shaped central portion, and thereby prevented from migrating into the gap, or onto the seat/console sides and floor. A textured outer side of the device grips the seat and console to secure it in position over the gap. The parallel top edges may include a sleeve extension having a textured under part that grips the seat to station the device thereon.

The end walls may have an accordion form, or a flat configuration. Alternatively, the device may include a top folding flap that secures convenience items inside the v-shaped central portion to prevent them from falling out. These folding flaps may be located on either side of the device. Materials for the end flap vary; however, preferably the material is a flexible material.

The device may be constructed from a mesh, ultra thin fabric, membrane or the like, to fit into tight spaces. Such an embodiment is especially suited for use with a wide variety of seat/gap geometries, since widths between the seat and the console vehicles, airplanes or boats are not the same. The device may have LED/fiber optic lighting therein. Alternatively, the device may include a fragrance stick insert therein. Colors of the device may vary. As well, the size of the device may vary. Generally, the device is appointed to be sized in an array of sizes to accommodate virtually any land vehicle, airplane and boat.

The LED/fiber optics are preferably provided as inserts, offering replaceable components and creating a secondary sale item. The fragrance insert stick is also a replaceable component that may be sold as a secondary sale item. The fragrance insert stick provides a novel way to deliver fragrance to a car/vehicle, airplane or boat, or provide a neutralizing scent insert for the vehicle, airplane or boat.

The console and bucket seat gap protective device includes first and second parallel top edges that are generally appointed to secure the device onto the seat and console. The device further includes a central portion located between the parallel edges. The central portion is appointed to catch and house items therein. The central portion extends between the console and the seat to prevent the items from falling there between. In one embodiment the central portion is a semi v-shaped central portion. In another embodiment the central portion is a semi arced-shaped central portion. Other embodiments provide for LED or fiber optic lighting to be integrated within the device to provide illumination. Fragrance emitting portions may be inserted into the device to provide fragrance emission or odor neutralization.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a illustrates a view of an embodiment of the console and bucket seat divider device/gap protective device placed in a vehicle and having a solid construction;

FIG. 1b illustrates a top side view of the gap protective device of FIG. 1a;

FIG. 1c illustrates a sectional underside view of the device of FIG. 1a;

FIG. 1d illustrates a top view of the device of FIG. 1a;

FIG. 2a illustrates a view of another embodiment of the console and bucket seat divider device/gap protective device placed in a vehicle wherein the central portion is composed of a mesh material;

FIG. 2b illustrates a top view of the device of FIG. 2a;

FIG. 3a illustrates an embodiment of the gap protective device having a solid construction and wherein the device includes LED/fiber optics and fragrances insert elements;

FIG. 3b illustrates a top side view of the gap protective device of FIG. 3a;

FIG. 3c illustrates a sectional underside view of the device of FIG. 3a;

FIG. 3d illustrates a top view of the device of FIG. 3a showing the LED/fiber optics and fragrance insert elements;

FIG. 3e illustrates a sectional view of the LED/fiber optics and fragrance insert elements;

FIG. 3f illustrates a top view of the device of FIG. 3a;

FIG. 4a illustrates an embodiment of the gap protective device having a mesh construction and wherein the device includes LED/fiber optics and fragrance inserts elements;

FIG. 4b illustrates a top view of the device of FIG. 4a; and

FIGS. 4c-4d illustrates sectional views of the exterior of the device of FIG. 4a showing the first and second parallel top edges.

### DETAILED DESCRIPTION OF THE INVENTION

A console and bucket seat gap protective device for preventing the falling of debris or small items between a seat and a console is provided by the present invention. The console and bucket seat gap protective device includes first and second parallel top edges that are generally appointed to secure the device onto the seat and console. The device further includes a central portion located between the parallel edges. The central portion is appointed to catch and house items therein. The central portion extends between the console and the seat to prevent the items from falling there between. In one embodiment the central portion is a semi v-shaped central portion. In another embodiment the central portion is a semi arced-shaped central portion. Other embodiments provide for LED or fiber optic lighting to be integrated within the device for providing illumination. Fragrant emitting portions may be inserted into the device to provide fragrance emission or odor neutralization.

Advantageously, the device is placed between the console and bucket seat of a land vehicle, airplane or boat to prevent items from falling there between. The gap protective divider is constructed from a lightweight, durable material including PVC materials, rubber, foam leather, mesh, heavy paper, coated paper or cardboard (for disposability) or other various materials or mixtures thereof. The divider may be provided as a liquid impermeable material so that if a liquid spills into the divider the liquid will be retained in the v-shaped central portion and the liquid will not travel between the gap onto the seat/console sides and floor. The device preferably includes a textured outer side appointed for gripping the seat and console for enhanced securement of the device over the gap. The parallel top edges may include a sleeve extension having a textured under part appointed to grip the seat. The end walls may be constructed with accordion walls, or alternatively flat walls. Alternatively, the device may include a top folding flap appointed to secure the items inside the v-shaped central portion to prevent the items from falling out. These folding flaps may be located on either side of the device. Materials for the end flap vary; however, preferably the material is a flexible material. The device may be constructed from a mesh material for the purpose of fitting into tighter spaces, being that the widths in between the seat and the console in mostly all vehicles, airplanes or boats are not the same. The device may have LED/fiber optic lighting therein. Alternatively, the device may include a fragrance stick insert therein. Colors of the device may vary. In addition, the size of the device may vary. Typically, the device is appointed to be sized in an array of sizes to accommodate a wide variety of vehicle seat-console designs. The LED/fiber optics are preferably provided as inserts, offering replaceable components and creating a secondary sale item. The fragrance insert stick is also a replaceable component that may be sold as a secondary sale item. The fragrance insert stick provides a novel way to deliver fragrance to a car/vehicle or provide a neutralizing scent insert to the vehicle.

Secondary sale items of the device include the optional LED/fiber optics insert, as well as the fragrance insert elements. The fragrance insert element involves a fragrance insert stick that is placed within the device and provides a novel way to fragrance or neutralize odor in a car. The device may have a solid construction or a mesh construction. The mesh construction allows the device to be manipulated to fit into tighter spaces wherein the widths in between the seat and the console in mostly all vehicles, airplanes or boats are not the same. Colors of the device may vary, as well as sizes and materials used in the construct.

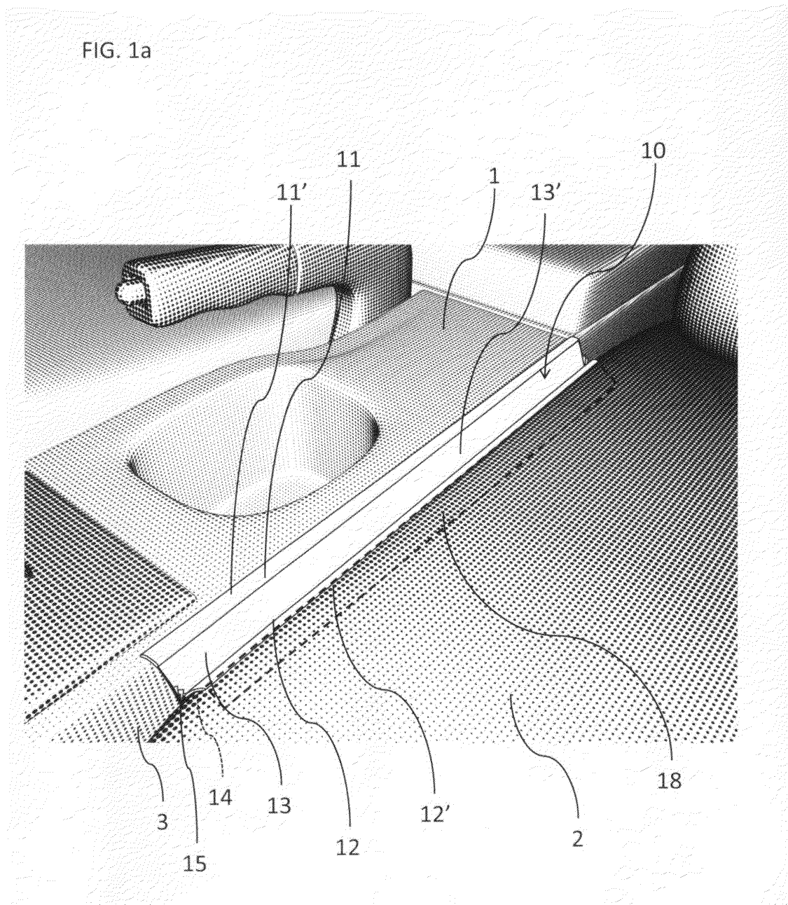

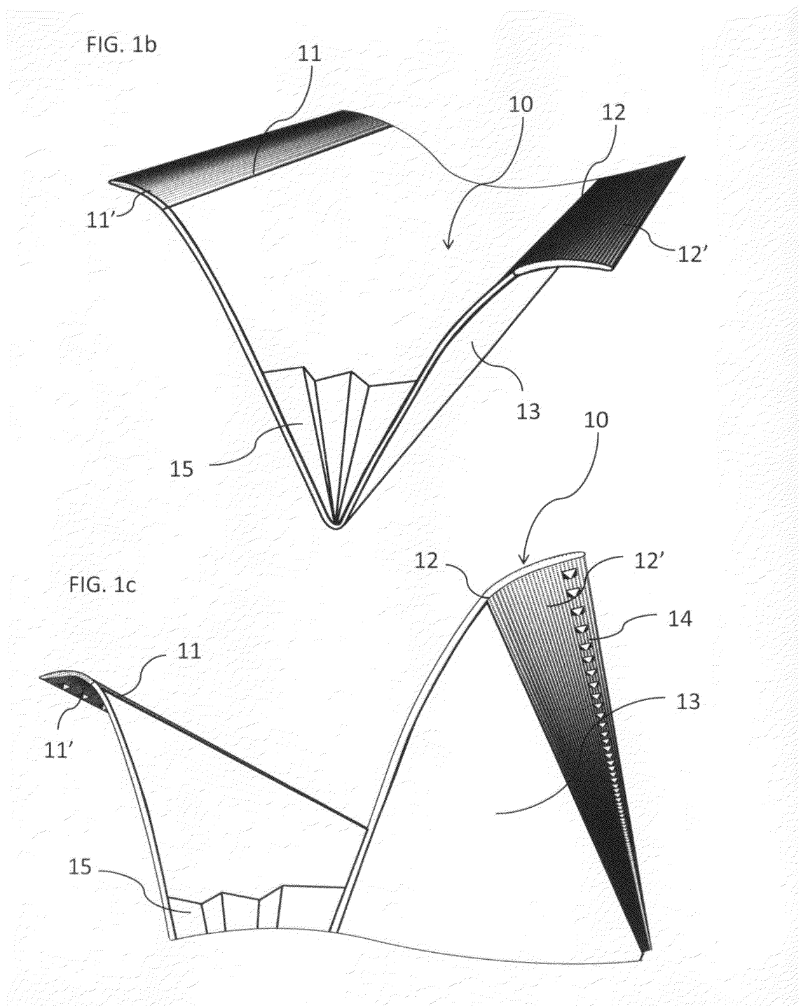

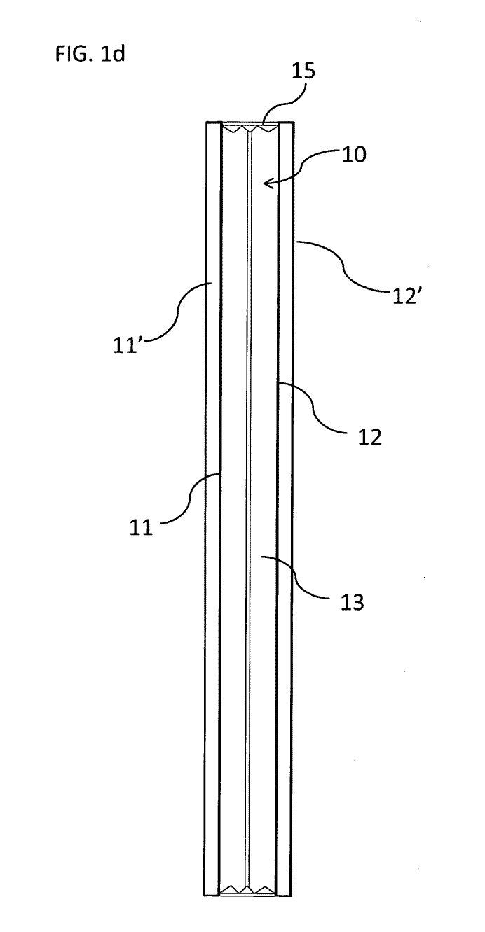

FIGS. 1a-1d illustrate views of a first embodiment of the console and bucket seat divider device/gap protective device having a solid construction. FIG. 1 shows the device placed in a vehicle; FIG. 1b illustrates a top side view; FIG. 1c illustrates a sectional underside view; and FIG. 1d illustrates a top view. A gap protective device 10 is provided placed between a console 1 and a bucket seat 2 over a gap 3. The gap protective device 10 is constructed having a first and second parallel top edge 11, 12 abutting a central portion 13. Central portion 13 is appointed to catch and house items therein that either fall between the console 1 and the seat 2, or are placed there. The central portion 13 extends between the console 1 and the seat 2 to prevent the items from falling there between.

First and second parallel top edge 11, 12 may have a very shallow depth, or may extend to provide sleeve extensions 11′, 12′. The sleeve extensions 11′, 12′ preferably include a friction undercoating or a textured underside 14 appointed to grip the seat 2 and console 1 to provide enhanced stability of the device 10. As depicted, central portion 13 preferably is constructed having a semi v-shaped central portion, however the central portion 13 can instead be a semi arced-shaped, or have a plethora of shapes. In order to ensure the items remain retained within the device 10, not only is the central portion 13 preferably v-shaped or arced, but it may include end walls 15. End walls 15 are preferably accordion walls as shown so that the device can be folded flat when not in use as when stored. Further, the accordion end walls allow the device 10 to be inserted and utilized on different gap 3 widths as the walls expand to ensure the device 10 fits within larger gaps 3 and contract to ensure the device 10 fits within smaller gaps 3. Alternatively, the end walls are flat walls.

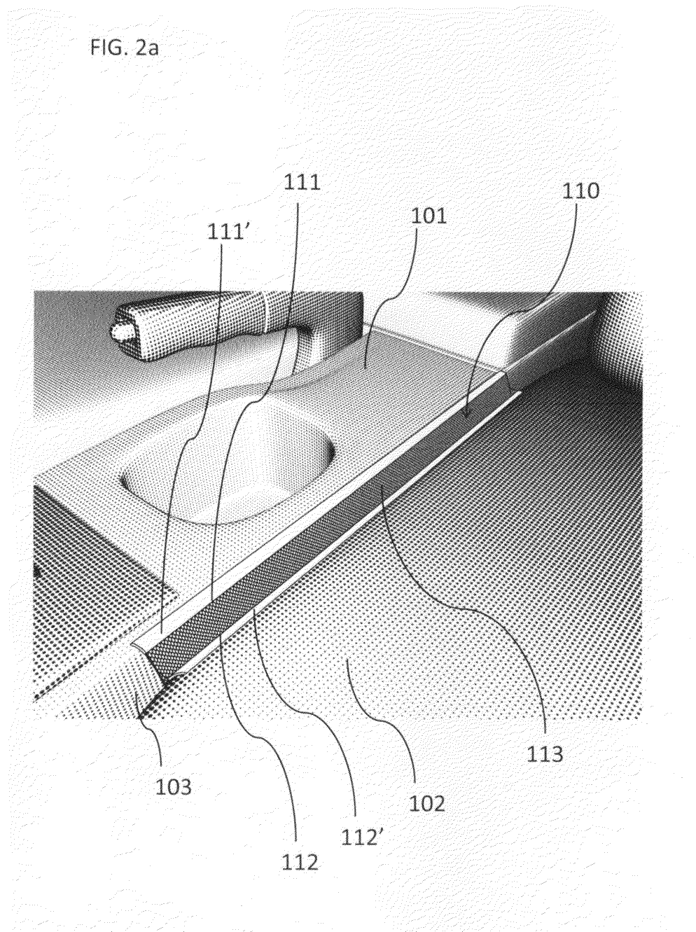

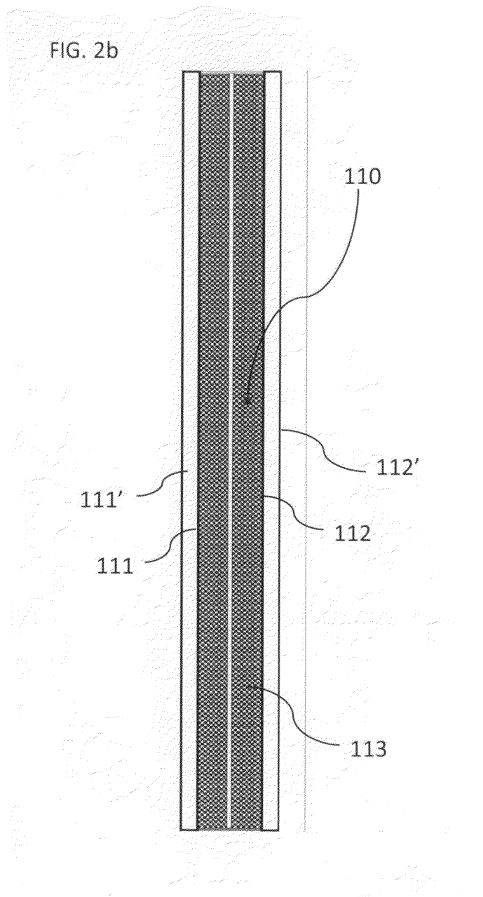

The device 10 may be constructed of a lightweight, durable material including PVC materials, rubber, foam or leather. The central portion 13 is herein shown being constructed of a solid construction 13′. In this manner central portion 13 forms a liquid impervious barrier and catches and retains liquid spillage preventing the liquid from flowing into gap 3 and causing a mess in the vehicle. What is more, central portion 13 may include at least one top folding flap (shown in phantom at 18); two folding flaps may be provided. Alternatively, the central portion 13 is constructed from a mesh material as discussed in FIG. 2a-2b.

FIGS. 2a and 2b illustrate views of another embodiment of the console and bucket seat divider device/gap protective device placed in a vehicle wherein the central portion is composed of a mesh material. A gap protective device 110 is provided placed between a console 101 and a bucket seat 102 over a gap 103. The gap protective device 110 is constructed having a first and second parallel top edge 111, 112 abutting a central portion 113. Central portion 113 extends between the console 101 and the seat 102 to prevent the items from falling there between. Preferably as shown, the first and second parallel top edges 111, 112 are constructed from a flexible material while the central portion 113 is constructed from a mesh material.

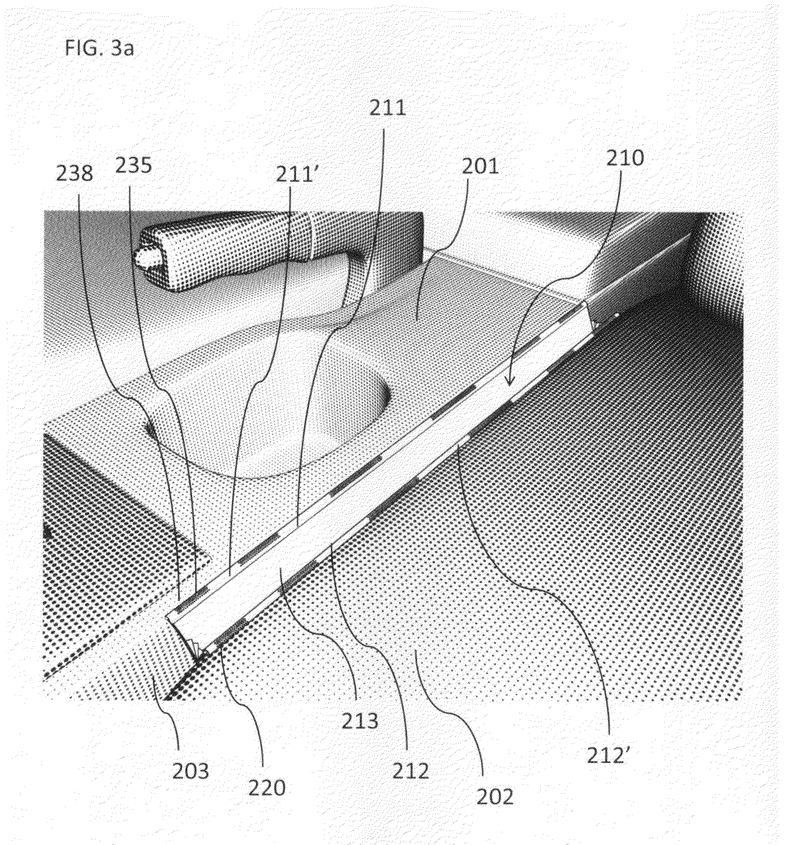

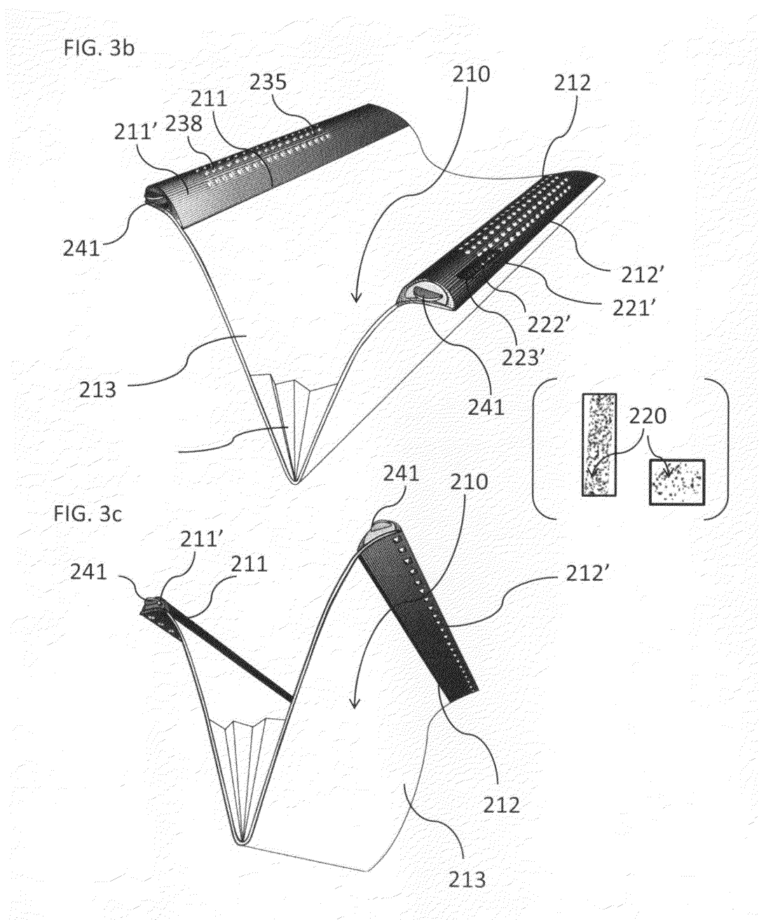

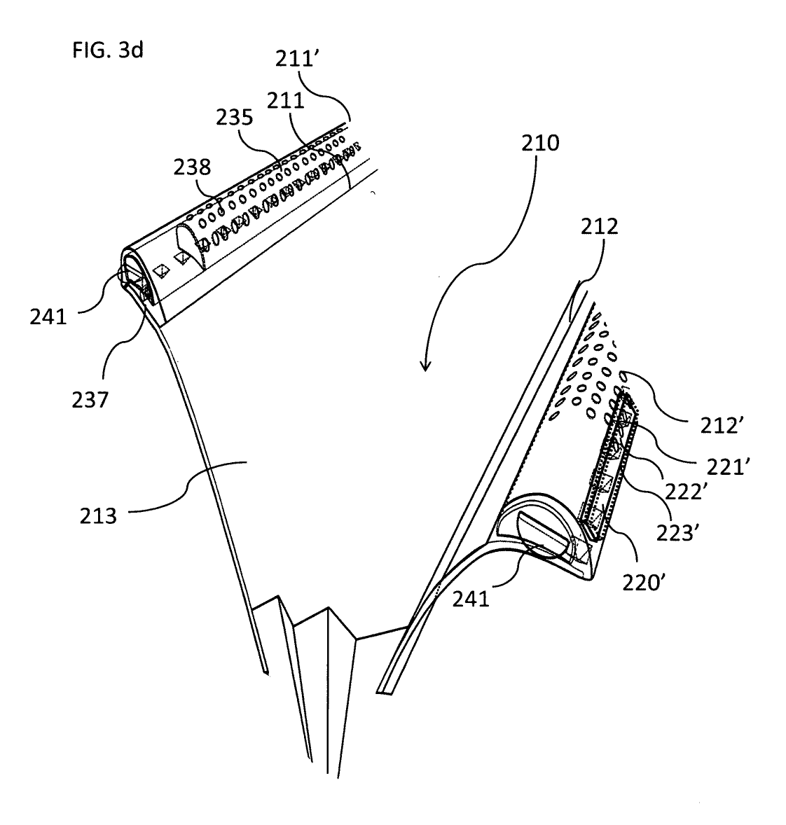

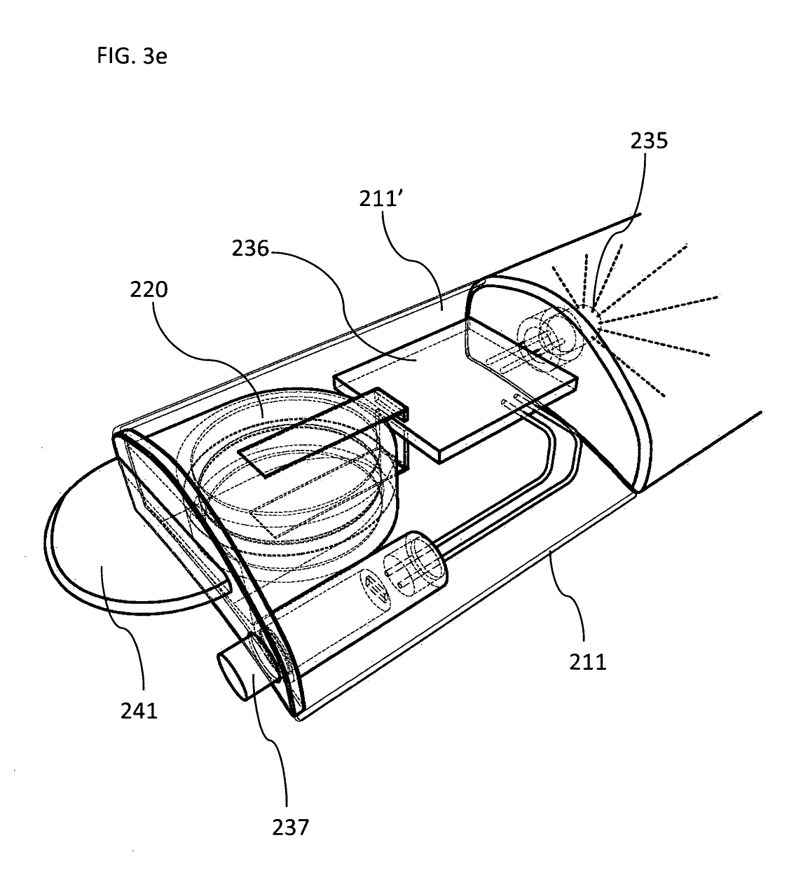

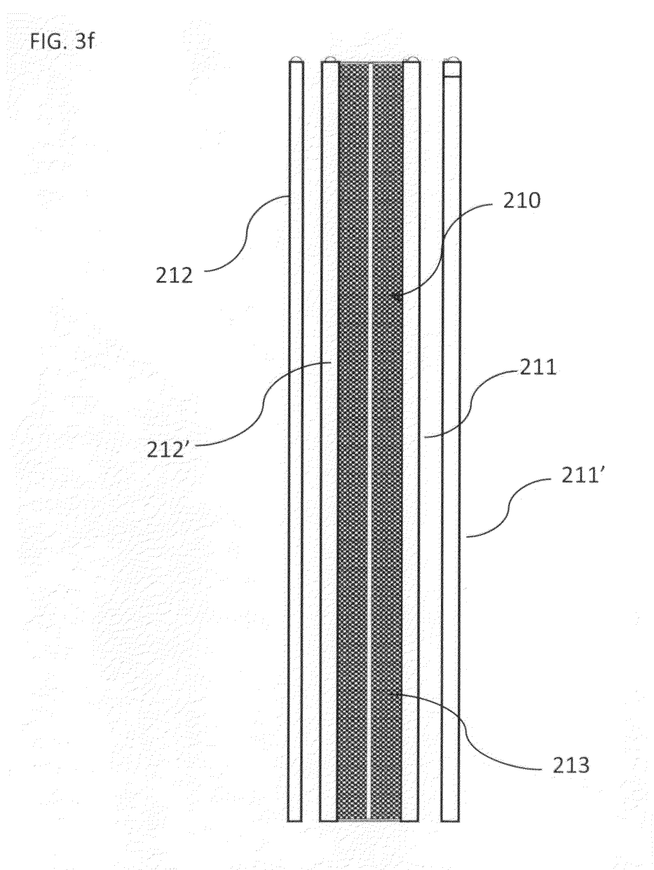

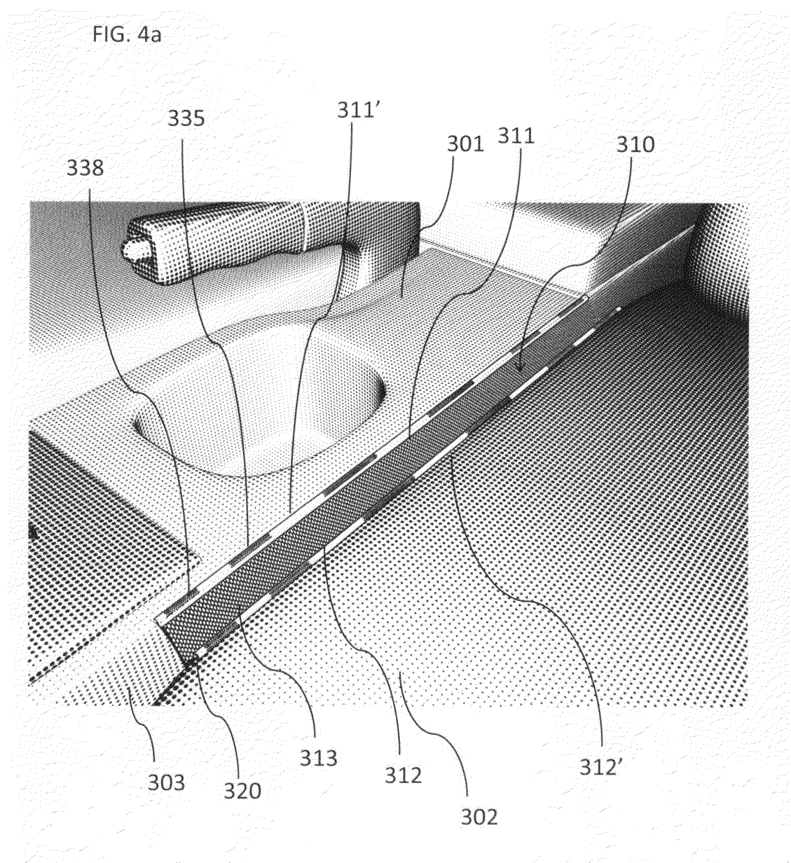

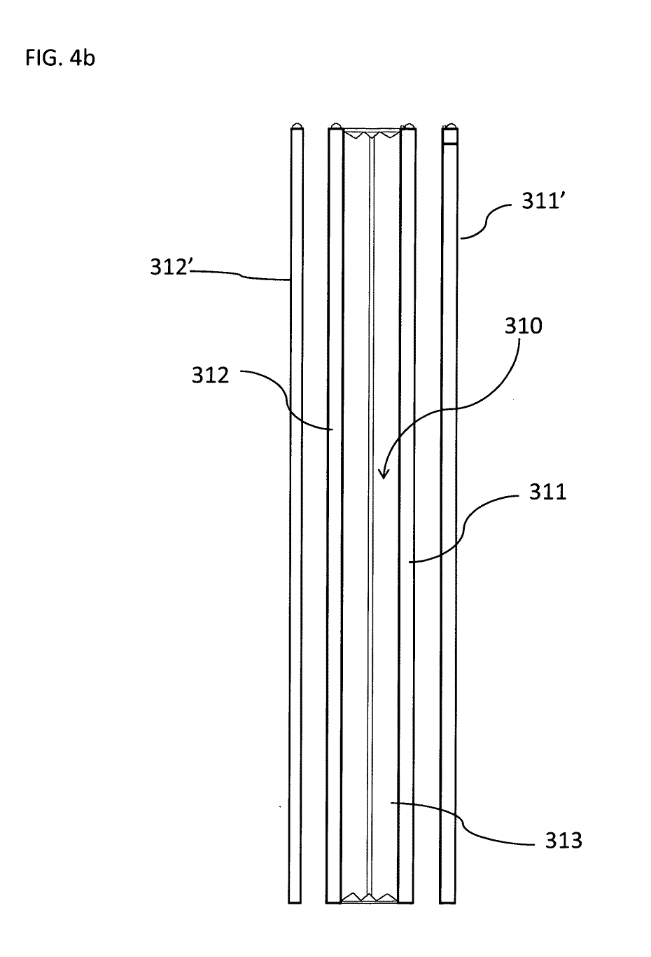

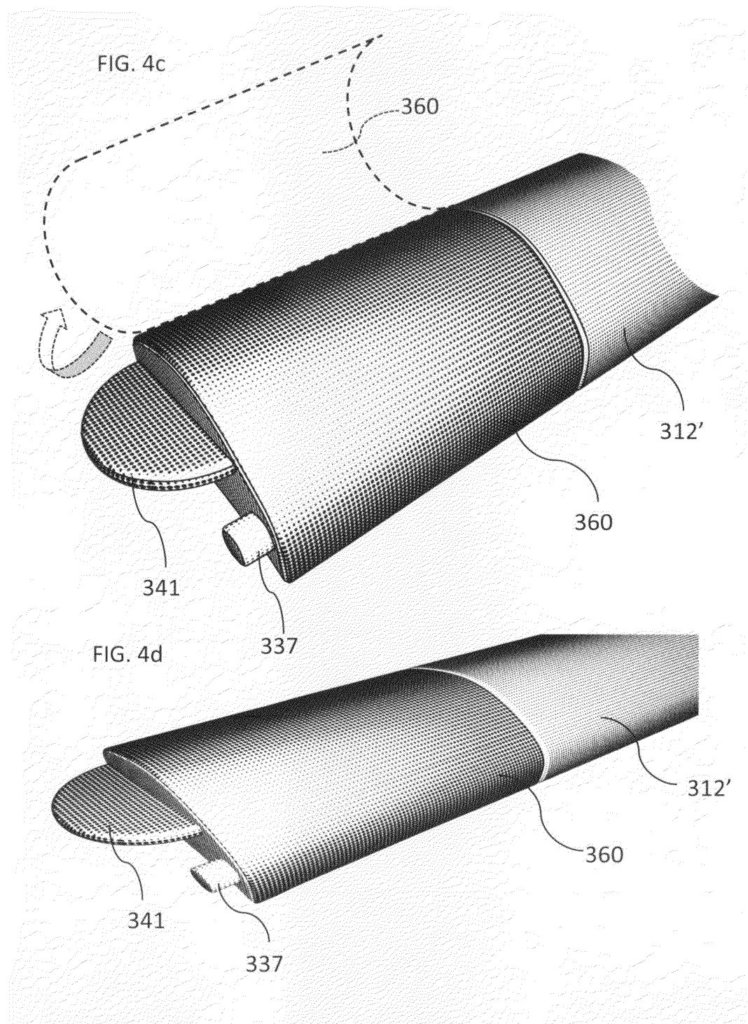

FIGS. 3a-3f illustrate embodiments of the gap protective device having a solid construction, and mesh construction, respectively, and wherein the device includes fragrance insert elements and/or LED/fiber optic lighting. FIG. 3a illustrates a top view of the device in a vehicle; FIG. 3b illustrates a top side view; FIG. 3c illustrates a sectional underside view; FIG. 3d illustrates a top view showing the LED/fiber optics and fragrance insert elements; FIG. 3e illustrates a sectional view of the LED/fiber optics and fragrance insert elements; and FIG. 3f illustrates a top view of the device. Referring to FIGS. 3a-3f, in the embodiments shown the gap protective device 210 is provided placed between a console 201 and a bucket seat 202 over a gap 203. It is constructed having a first and second parallel top edge 211, 212 abutting a central portion 213 composed of a solid material/solid construction. Preferably as shown, the first and second parallel top edges 211, 212 are constructed with fragrance insert elements 220. The fragrance insert elements 220 may include a plurality of apertures 221′ leading to a shallow cavity 222′ with a hinged door 223′ that opens to the cavity 222′ located within the second parallel top edges 211, 212 or sleeve extension 211′, 212′ which receive and house a fragrance stick that is appointed to be replaced as needed. Preferably at least one light-emitting diode (LED)/fiber optic lighting 235 is integrated within the device. LED or fiber optic lighting 235 is preferably located within each of said first and second parallel top edges 211, 212 or sleeve extension 211′, 212′. The LED or fiber optic lighting 235 includes a power source or battery 236 in communication with an on/off switch 237 which when activated turns the LED or fiber optic lighting 235 on. The light is emitted from the device 210 through a plurality of apertures 238. The first and second parallel top edges 211, 212 or sleeve extension 211′, 212′ preferably includes a hinged portion (see 360 in FIGS. 4c, 4d) that opens so that the user has access to the battery 236, LED/fiber optic lighting 235 and/or the fragrance element 220. A closure lock 241 is provided for opening and closing the hinged portion (see 360 in FIGS. 4c, 4d).

FIGS. 4a-4d illustrates an embodiment of the gap protective device having a mesh construction and wherein the device includes LED/fiber optics and fragrance insert elements. FIG. 4a illustrates a view of the device in a vehicle; FIG. 4b illustrates a top view; FIGS. 4c- 4d illustrates sectional views of the exterior of the first and second parallel top edges or sleeve extension 311′, 312′. In this embodiment the gap protective device 310 is provided placed between a console 301 and a bucket seat 302 over a gap 303. It is constructed having a first and second parallel top edge 311, 312 abutting a central portion 313 composed of a mesh material/mesh construction. The first and second parallel top edges 311, 312 are constructed having fragrance insert elements 320. Additionally, preferably at least one light-emitting diode (LED)/fiber optic lighting 335 is integrated within the device. LED or fiber optic lighting 335 is preferably located within each of said first and second parallel top edges 311, 312 or sleeve extension 311′, 312′. The first and second parallel top edges 311, 312 or sleeve extension 311′, 312′ preferably includes a hinged portion 360 that opens so that the user has access to the battery, LED/fiber optic lighting 335 and/or the fragrance element 320. A closure lock 341 is provided for opening and closing the hinged portion 360.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A console and bucket seat gap protective device, comprising:
a. a first and second substantially parallel top edge; and
b. a central portion appointed to catch and house items;
wherein said central portion extends between said console and said seat to prevent said items from falling there between.

2. A console and bucket seat gap protective device as recited by claim 1, wherein said first and second substantially parallel top edges include sleeve extensions.

3. A console and bucket seat gap protective device as recited by claim 2, wherein said sleeve extensions include a friction undercoating appointed to grip said seat.

4. A console and bucket seat gap protective device as recited by claim 2, wherein said sleeve extensions include a textured underside appointed to grip said seat.

5. A console and bucket seat gap protective device as recited by claim 1, wherein said central portion is a semi v-shaped central portion.

6. A console and bucket seat gap protective device as recited by claim 1, wherein said central portion is a semi arced-shaped central portion.

7. A console and bucket seat gap protective device as recited by claim 1, wherein said central portion includes end walls.

8. A console and bucket seat gap protective device as recited by claim 8, wherein said end walls are accordion walls.

9. A console and bucket seat gap protective device as recited by claim 8, wherein said end walls are flat walls.

10. A console and bucket seat gap protective device as recited by claim 1, wherein said device is constructed of a lightweight, durable material including plastic, PVC materials, metal, rubber, foam, mesh, coated paper, cardboard or leather.

11. A console and bucket seat gap protective device as recited by claim 1, wherein said central portion is constructed of a solid construction.

12. A console and bucket seat gap protective device as recited by claim 1 comprising at least one top folding flap.

13. A console and bucket seat gap protective device as recited by claim 12, wherein two folding flaps are provided.

14. A console and bucket seat gap protective device as recited by claim 1, wherein said central portion is constructed from a mesh material.

15. A console and bucket seat gap protective device as recited by claim 14, wherein said first and second parallel top edges are constructed from a flexible material and said central portion is constructed from said mesh material.

16. A console and bucket seat gap protective device as recited by claim 1 comprising at least one light-emitting diode (LED).

17. A console and bucket seat gap protective device as recited by claim 1 comprising fiber optic lighting.

18. A console and bucket seat gap protective device as recited by claim 16 or 17, wherein said LED or fiber optic lighting is located within each of said first and second parallel top edges.

19. A console and bucket seat gap protective device as recited by claim 16 or 17, wherein said LED or fiber optic lighting is located within sleeve extensions for at least one of said first and second parallel top edges.

20. A console and bucket seat gap protective device as recited by claim 1 comprising at least one fragrance insert element.

21. A console and bucket seat gap protective device as recited by claim 20, comprising a plurality of fragrance insert elements, said fragrance insert elements being located within each of said first and second parallel top edges.

22. A console and bucket seat gap protective device as recited by claim 20, wherein said fragrance insert elements is located within sleeve extensions of each of said first and second parallel top edges.

23. A console and bucket seat gap protective device as recited by claim 1, wherein said central portion is composed of coated paper or cardboard, so that said device is eco-friendly and disposable.
